(19) United States
(12) Patent Application Publication
(10) Pub. No.: US 2014/0209430 A1
(43) Pub. Date: Jul. 31, 2014

(54) Construction Panel Slider

(71) Applicant: Ryan Tanner, Osler (CA)

(72) Inventor: Ryan Tanner, Osler (CA)

(21) Appl. No.: 14/136,637

(22) Filed: Dec. 20, 2013

Related U.S. Application Data
(60) Provisional application No. 61/759,177, filed on Jan. 31, 2013.

(51) Int. Cl. B65G 11/02

(52) U.S. Cl. CPC B65G 11/023
USPC 193/2 R

(57) ABSTRACT

Provided is an apparatus to assist manual transport of construction panels, such as drywall panels. The construction panel apparatus is particularly suitable for moving construction panels down inclines, such as stairways, and allows a user to slide the construction panel along the apparatus rather than having to carry the construction panel.

### CROSS REFERENCE TO RELATED APPLICATIONS

This application claims benefit under 35 U.S.C. 119(e) of Provisional Application Ser. No. 61/759,177, filed Jan. 31, 2013.

### FIELD

This disclosure relates to the field of apparatuses and methods for moving construction panels, particularly to apparatuses and methods for moving construction panels along inclines such as stairways.

### BACKGROUND

When working on a job site, construction workers are frequently required to transport construction panels, such as drywall panels, that are heavy and awkward to manipulate. Construction panels are particularly difficult to move along inclines; such as down stairways, down stairwells that do not yet have stairs, or when being unloaded from a raised transport vehicle. Construction workers typically carry construction panels down stairways and this act is a common source of injury due to strains and falls. Further, it can be difficult to navigate stairways when carrying a construction panel and care must be taken to avoid damaging surrounding structures such as walls and headers.

Slides to assist in moving drywall or other construction panels through windows are known, such as those sold by Robert's Diesel Works Inc. in Orlando, Fla. at http://www.drywalltrucks.net/slides.htm, and that described in U.S. Pat. No. 5,042,222. However, these slides are of limited length, spanning only slightly further than the depth of a window sill, and they are not designed to independently support the weight of a construction panel over a span. They merely provide a smooth slick surface that can be placed over or joined to a window sill to enable a drywall panel to be slid over the sill.

A known method of moving heavy objects up and down stairs is to use a board to form a ramp along a stairway. Use of a board in this fashion will make it possible to roll or slide objects up and down the stairway, however, it is not very efficient as the board provides significant friction, which can slow the moving process and may damage the object being moved. Additionally, care must be taken to prevent the object from moving off the edge of the board, which can slow the moving process and may present a danger to the person or persons moving the object. Further, boards of different lengths must be used for different lengths of stairways.

There remains a desire for an effective, efficient, and safe way to move a construction panel along an incline, such as a stairway.

### SUMMARY

Provided is an apparatus to assist in the manual transport of construction panels, such as drywall panels, by sliding the construction panel along the apparatus. The construction panel slider is particularly suited for moving construction panels down inclines, such as stairways, and allows a user to slide the construction panel along the apparatus rather than having to carry the construction panel. Further provided is a method of moving a construction panel using a construction panel slider as described herein.

One embodiment is an apparatus for moving a construction panel by sliding along the apparatus, the apparatus comprising a plurality of sections, each section comprising a base comprising a top face, a bottom face, a first side, a second side, a first end and a second end; a first side wall joined to the first side of the base and a second side wall joined to the second side of the base; and a slide surface joined to the top face of the base and situated between the first and second side walls, wherein said slide surface comprises an upper face and the first and second side walls extend beyond the upper face of the slide surface, wherein the sections are arranged end to end and adjacent sections are movably joined.

In an embodiment, at least one section of the apparatus for moving a construction panel is an elongated section. In a further embodiment, at least one section is of a different length than at least one other section.

In an embodiment, the apparatus for moving a construction panel comprises at least one attachment member joined to an end of the apparatus.

In an embodiment, the apparatus for moving a construction panel comprises a securement member joined to at least one end of the apparatus.

In a further embodiment, the first and second side walls of the apparatus for moving a construction panel are integral with the base of said apparatus.

In another embodiment, the apparatus for moving a construction panel comprises a connector joined to the outer surface of at least one side wall, wherein when the apparatus is in a folded position the connector is arranged to retain the apparatus in the folded position.

In an embodiment, adjacent sections of the apparatus for moving a construction panel are pivotally joined.

A further embodiment is an apparatus for moving a construction panel by sliding along the apparatus, the apparatus comprising an elongated base comprising a top face, a bottom face, a first side, and a second side; a first side wall joined to the first side of the base and a second side wall joined to the second side of the base; and a slide surface joined to the top face of the base and situated between the first and second side walls, wherein the slide surface comprises an upper face and the first and second side walls extend beyond the upper face of the slide surface.

In an embodiment, the apparatus for moving a construction panel comprises at least one attachment member joined to an end of the apparatus. In an additional embodiment, the apparatus comprises a securement member joined to at least one end of the apparatus.

Another embodiment is an apparatus for moving a construction panel by sliding along the apparatus, the apparatus comprising at least one section, each section comprising an elongated base comprising a top face; a slide surface joined to the top face of the elongated base; and a first side wall joined to one side of the slide surface and a second side wall joined to the opposite side of the slide surface, such that the slide surface is situated between spaced apart first and second side walls, wherein the slide surface comprises an upper face and the first and second side walls extend beyond the upper face of the slide surface.

In an embodiment, the first and second side walls of the apparatus for moving a construction panel are integral with the slide surface. In a further embodiment, the first side wall, the slide surface, and the second side wall together are of a half-pipe configuration.

In an embodiment, the apparatus for moving a construction panel comprises a plurality of sections, wherein the sections are arranged end to end and adjacent sections are movably joined. In a further embodiment, the apparatus comprises an attachment member joined to at least one end of the apparatus.

An additional embodiment is a method of moving a construction panel comprising sliding at least one construction panel along the slide surface of an apparatus of any one of claims 1 to 16, such that the weight of the construction panel is supported at least in part by the apparatus as the construction panel moves along the slide surface of the apparatus.

In an embodiment, the method comprises a step of placing the apparatus over the treads of a stairway before sliding the at least one construction panel along the slide surface. In a further embodiment, the method comprises a step of securing the apparatus to impede the apparatus from shifting position as the construction panel is being moved along the slide surface. In an embodiment, securing the construction panel apparatus comprises securing the apparatus through engagement with a human appendage.

### BRIEF DESCRIPTION OF DRAWINGS

FIG. 1 illustrates a top plan view of an embodiment of a construction panel slider of the disclosure.

FIG. 2 illustrates a side elevation view of the construction panel slider of FIG. 1.

FIG. 3 illustrates a bottom plan view of the construction panel slider of FIG. 1.

FIG. 4 illustrates an end elevation view of the construction panel slider of FIG. 1.

FIG. 5 illustrates a top plan view of a second embodiment of a construction panel slider of the disclosure.

FIG. 6 illustrates a side elevation view of the construction panel slider of FIG. 5.

FIG. 7 illustrates a bottom plan view of the construction panel slider of FIG. 5.

FIG. 8 illustrates a side elevation view of the construction panel slider of FIG. 5, when the apparatus is partially folded.

FIG. 9 illustrates a side elevation view of the construction panel slider of FIG. 5, when the apparatus is folded for transport.

FIG. 10 illustrates a side elevation view of the construction panel slider of FIG. 5, when the apparatus is placed over a stairway.

FIG. 11 illustrates a top plan view of a third embodiment of a construction panel slider.

FIG. 12 illustrates a side elevation view of a fourth embodiment of a construction panel slider, when the apparatus is folded for transport.

FIG. 13 illustrates a side elevation view of a fifth embodiment of a construction panel slider.

FIG. 14 illustrates an end elevation view of the construction panel slider of FIG. 13.

FIG. 15 illustrates a top plan view of a third embodiment of a construction panel slider of the disclosure.

FIG. 16 illustrates an end elevation view of the construction panel slider of FIG. 15.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense. Further, where considered appropriate, reference numerals may be repeated among the figures to indicate corresponding or analogous elements.

The present disclosure provides generally an apparatus for moving one or more construction panels, the apparatus is also referred to herein as a construction panel slider. In particular the disclosure relates to an elongated construction panel slider comprising a slide surface situated between two side walls. The construction panel slider is designed to allow a user to slide one or more construction panels along its slide surface and is particularly suited for use on an incline, such as a stairway. The construction panel slider can also be used to move one or more construction panels along a substantially horizontal surface.

As used herein, the term construction panel refers to a sheet of construction material such as drywall, gypsum board, plywood, aqua board, cement board, plaster board, green board, moisture board, wall board, or any other sheet of construction material as will be known to a person skilled in the art. As used herein, the term construction panel also includes other panel-shaped construction materials such as doors; closets; plywood; shelving; windows; siding materials; finishing materials, for example baseboards; taping and mud products, for example pails or boxes; cardboard boxes; boxes of building materials such as nails or staples; shingles; lumber, for example 2×4's; cabinet materials; and sheetrock. As used herein, the terms elongated base and elongated section refer to a base or section that is longer in the slide or longitudinal direction, i.e. the direction parallel to the side walls, than it is in width, i.e. the direction perpendicular to the side walls.

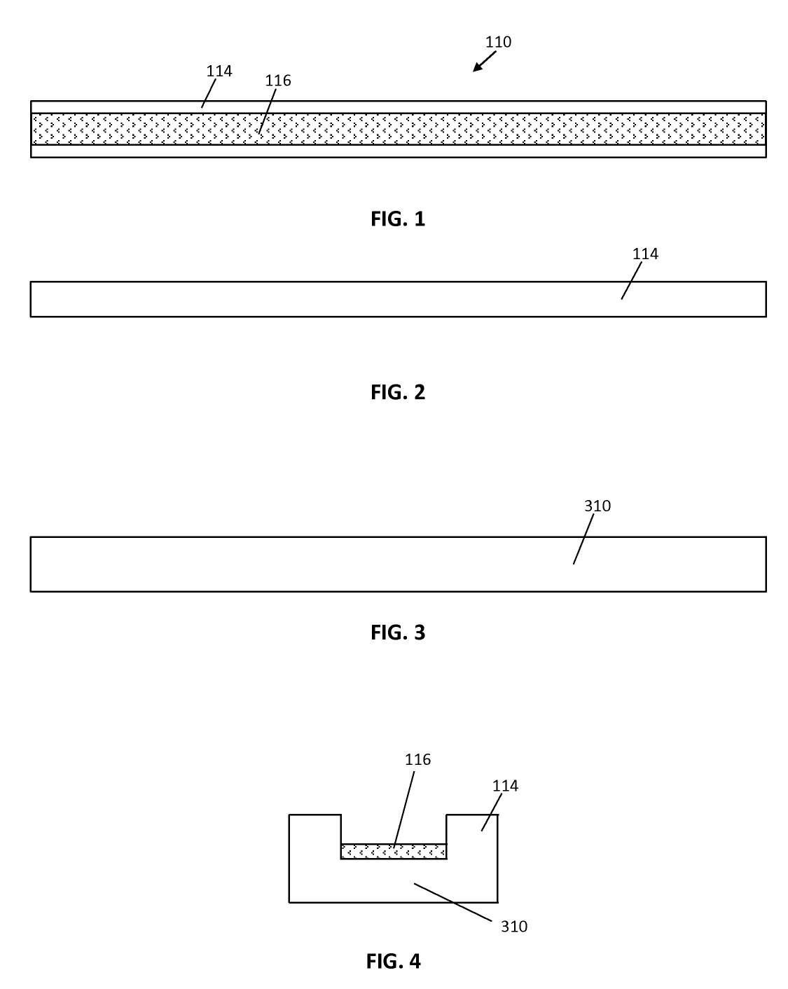

A first embodiment of a construction panel slider is illustrated in FIGS. 1 to 4. The construction panel slider 110 comprises a pair of parallel side walls 114 that are joined to the parallel longitudinal sides of an elongated rectangular base 310. As illustrated in FIG. 4, the side walls 114 may be integral with base 310 or they may be distinct structures that are joined to base 310, either along the sides of base 310 and/or along the side portions of the upper face of base 310. For example, side walls 114 may be moulded to base 310 or they may be joined to base 310 by one or more fasteners and/or by a weld or adhesive.

Joined to the upper face of base 310 and situated between side walls 114 is a slide surface 116. Slide surface 116 should be sufficiently smooth and have a sufficiently low co-efficient of friction to allow a construction panel to slide along its surface, preferably without damaging the construction panel. The slide surface material should also be able to withstand repeated use. Examples of suitable materials for slide surface 116 include polyvinylchloride, Teflon, EZ Glide, carpet, linoleum, plywood, wooden boards, steel, tin, aluminum, vinyl, glass, metals, acrylic, laminate, granite, marble, and high density polyethylene.

In the illustrated embodiments, slide surface 116 is shown as being made of a different material than base 310 and side walls 114, but in other embodiments slide surface 116 may be made of the same material as base 310 and/or side walls 114 and may be integral with base 310 and/or side walls 114.

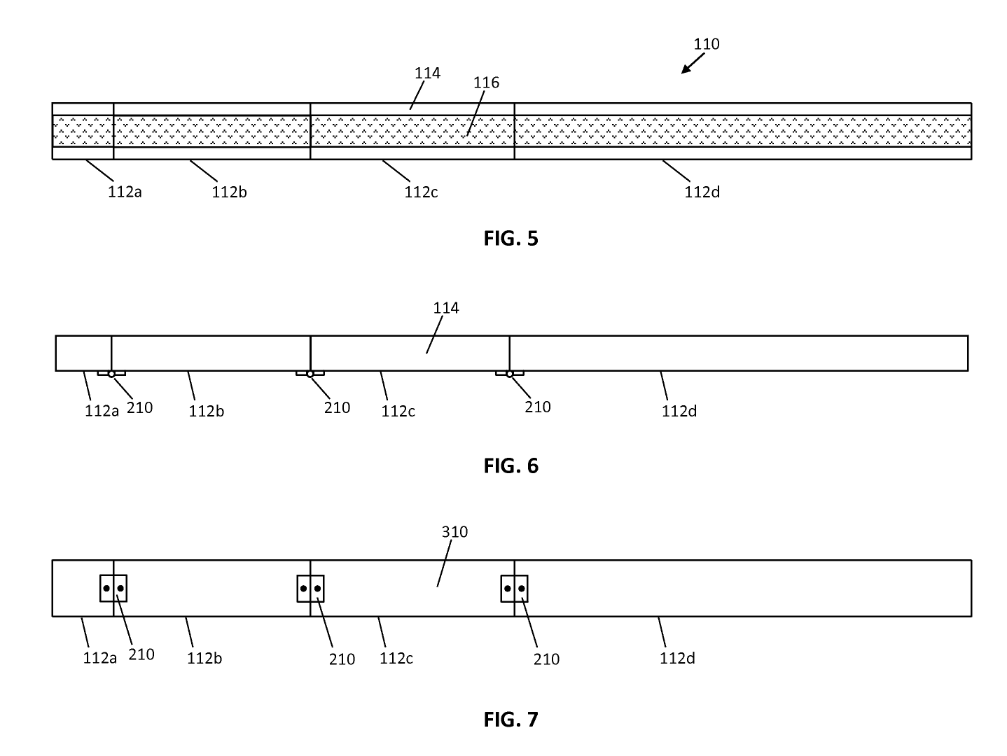

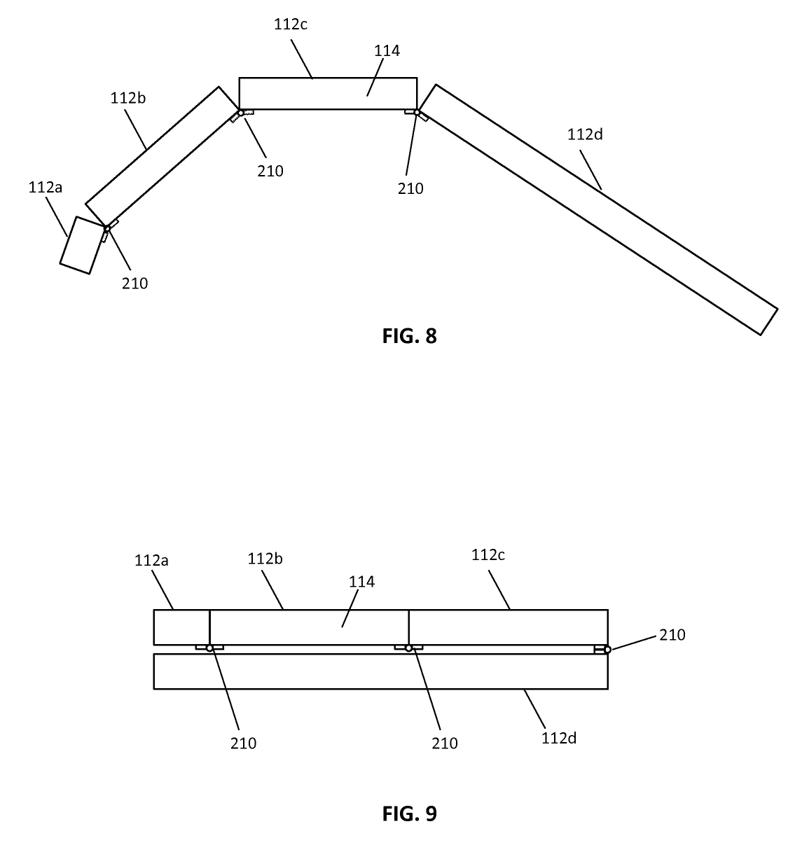

FIGS. 5 to 10 depict a second embodiment of a construction panel slider. In this embodiment, the construction panel slider 110 is made up of a plurality of sections 112a, 112b, 112c, and 112d that are aligned end to end and joined by pivots 210. In an embodiment, pivot 210 is a hinge attached to the ends of two adjacent sections to allow relative pivoting between the two sections about a transverse axis that lies parallel to the ends of the bases and perpendicular to the longitudinal dimensions thereof. These pivots 210 allow the construction panel slider 110 to be folded about the transverse hinge or pivot axes for transport or for use to move the construction panel a shorter distance than the full extended length of construction panel slider 110, for example the construction panel slider 110 may be folded or compacted as shown in FIG. 9, in which section 112d has been folded into a tucked-under storage position residing beneath, and parallel to, the other sections 112a, 112b, 112c. In the storage position, using the term ‘underside’ to mean the side of the base lying opposite the sliding surface, with the underside of the base of section 112 faces the undersides of the coplanar bases of the other sections 112a, 112b, 112c. In a non-illustrated embodiment, sections 112 may be joined by a connector other than a pivot or hinge, such as a latch, clamp, clasp, clavicle, buckle, strap, or pin such as a hairpin or cotter pin. In an embodiment, the connector used to join sections 112 may be a releasable connector, such that a plurality of sections may be joined by a user to form a construction panel slider and later released, for example for transport or storage.

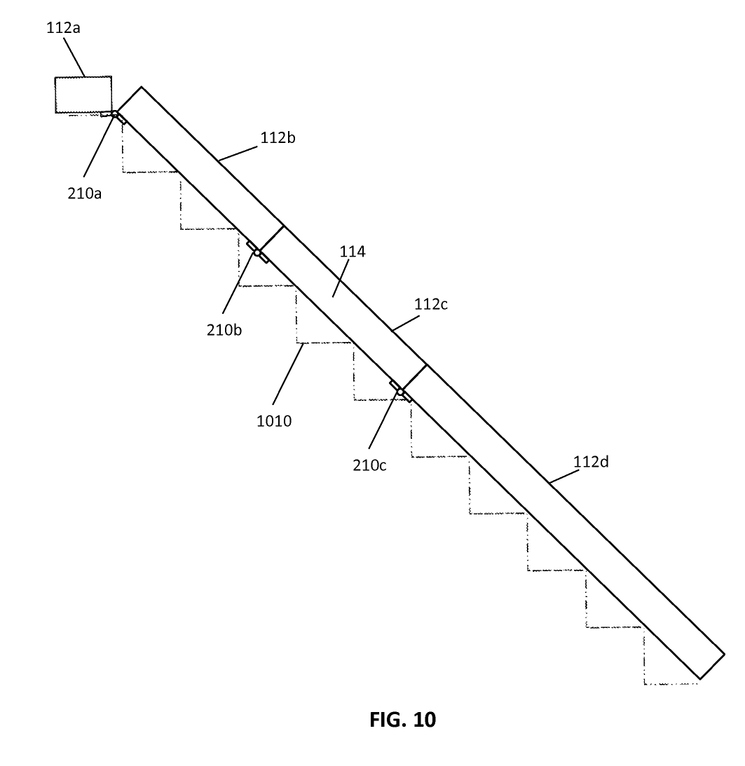

As shown in FIG. 10, construction panel slider 110 may be placed along a stairway 1010 and one or more sections 112 may be laid flat along the top and/or bottom of the stairwell. For example, in FIG. 10, the underside of section 112a is laid flat along the top of the stairwell while the undersides of sections 112b, 112c, and 112d lay along the stairs in the oblique plane running from the lip or front edge of one stair tread to the next over the full flight of stairs. In this way, construction panel slider 110 can be configured to accommodate stairways of different lengths. In some embodiments, the construction panel slider can be adjusted to accommodate stairways of 4-6 steps, 7-9 steps, 9-11 steps, and 17-22 steps, although other configurations are possible depending on the lengths of sections 112 relative to the dimensions of the stairway. Further, when one or more sections 112 are laid flat along the top and/or bottom of the stairway, these sections can be secured in place, for example by a clamp or by the hand or foot of a user, to impede the construction panel slider 110 from shifting position.

In FIG. 10, the pivot joining the topmost two sections, pivot 210a, is shown as positioned directly over the front edge of the top stair tread. In another embodiment, the construction panel slider may be positioned so that top section 112a extends beyond the front edge of the top stair tread, such that pivot 210a is not directly supported by a stair tread and is free to pivot in response to movement of section 112a as a panel is slid along section 112a and onto the remaining sections (112b, 112c, and 112d). This allows the angle of section 112a of the construction panel slider to conform to the angle of the panel being moved and reduces the potential for damage to the panel as it slides along the construction panel slider.

In the embodiment illustrated in FIGS. 5 to 10, the construction panel slider 110 comprises four sections 112a to 112d, but the construction panel slider 110 may comprise any number of sections. For example, the construction panel slider 110 may comprise 2 sections, 3 sections, 4 sections, 5 sections, 6 sections, 7 sections, or 8 or more sections. Further, the length of each section 112 may differ from the proportions shown in FIGS. 5 to 10. The sections may all be of equal length or the sections may differ in length. The construction panel slider 110 may also comprise two or more sections of equal length and additional sections of differing lengths.

In an embodiment, the construction panel slider 110 may further comprise one or more add-on extensions that may be added onto the base slider at either the top or the bottom when the length of the stairway exceeds the length of the construction panel slider 110. An add-on extension can also be used to connect to the top and/or bottom of the construction panel slider, when the slider runs along a stairway, to run flat along the upper and/or lower floor. The add-on extension may be joined to construction panel slider 110 by one or more connectors such as an eye bolt, hook, latch, clamp, clasp, clevice, buckle, tie-down strap, or pin such as a hairpin or cotter pin. Alternately, two or more construction panel sliders 110 may be connected to run the length of a long stairway that exceeds the length of a single construction panel slider 110. In an embodiment, two or more construction panel sliders 110 may be connected, wherein one or more construction panel slider runs along the stairway with another one or more construction panel slider 110 connecting at the top to run flat along the upper and/or bottom floor. The two or more construction panel sliders 110 may be joined by one or more connectors such as an eye bolt, hook, latch, clamp, clasp, clevice, buckle, tie-down strap, or pin such as a hairpin or cotter pin.

An add-on extension may range anywhere from about 16 inches to about 16 feet in length, or longer, depending on the length of extension required. The design and function of the add-on extension will be similar or identical to that of the construction panel slider, comprising an elongated base, side walls, and slide surface. The add-on extension may comprise a single section or a plurality of joined sections, arranged and joined as described herein for the construction panel slider. In an embodiment, the slide surface of the add-on extension may be equal to or higher than the slide surface of the construction panel slider when the add-on extension is intended to be joined to the top of the construction panel slider. For example, the slide surface of the add-on extension may be up to about 0.25 inches higher than the slide surface of the construction panel slider. Conversely, when the add-on extension is intended to be joined to the bottom of the construction panel slider, the slide surface of the add-on extension may be equal to or lower than the slide surface of the construction panel slider. For example, the slide surface of the add-on extension may be up to about 0.25 inches lower than the slide surface of the construction panel slider.

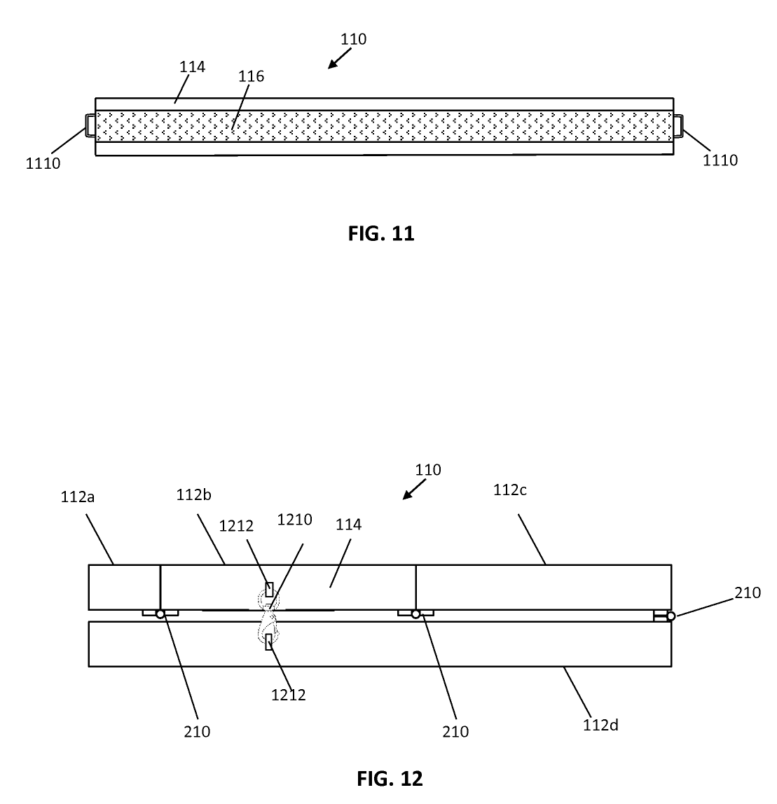

As illustrated in FIG. 11, the construction panel slider 110 may comprise one or more attachment members 1110 joined to the construction panel slider. These attachment members 1110 provide an attachment point for securing the construction panel slider in position. For example, a securement member such as a strap, for example a ratchet strap or tie-down strap; rope; latch; hook; or clamp may be joined to, passed through, or otherwise engaged with at least one attachment member 1110 to secure the construction panel slider to a structure or object such as a door, hook, rail, cart, vehicle, securement member such as a nail or hook that has been joined to the floor or to an existing structure in an unfinished building, door frame, or framing member of an unfinished building. The securement member may also be held in position by a user. In a further embodiment, the construction panel slider 110 comprises at least one attachment member for attaching the securement member to the construction panel for storage or transit. For example, the construction panel slider 110 may comprise one or more attachment members joined to a side wall of the construction panel slider (not shown) that allow the user to join the securement member to the side wall of the construction panel slider 110 for storage or transit. This allows the securement member to be kept together with the construction panel slider 110, where it is easily accessible and ready for use. An example of a suitable attachment member is an eye bolt or other member or feature similarly defining a closed, preferably rigid, loop through which a securement member may be looped, tied or hooked to the attachment member. For example, the attachment member may be an eye bolt, U-bolt, or i-bolt. The attachment member could also be another type of fastener such as a strap, catch, snap, hook and eye closure, magnetic fastener, or any other suitable fastener as will be understood to a person skilled in the art.

While FIG. 11 illustrates a construction panel slider comprising a single attachment member 1110 joined to each end of the construction panel slider, different numbers of attachment members 1110 may be joined to each end of the construction panel slider. For example, zero, one, two or more attachment anchors may be joined to each end of the construction panel slider. Further, attachment members 1110 may be joined to the construction panel slider 110 in other positions, for example they may be joined to one or both side walls of the construction panel slider, provided the attachment anchors do not obstruct the slide surface. Further, the attachment members 1110 may be of any size, shape, and configuration that allows for engagement with a securement member, provided that the attachment members 1110 do not impede movement of a construction panel along slide surface 116. For example, the attachment member 1110 may be an eye bolt or other member or feature similarly defining a closed, preferably rigid, loop through which a securement member may be looped, tied or hooked to the attachment member. For example, attachment member 1110 may be an eye bolt, U-bolt, or i-bolt.

As illustrated in FIG. 12, the construction panel slider 110 may comprise one or more connectors 1210 that engage connector retaining members 1212 joined to a side wall of the construction panel slider. The connector 1210 and connector retaining members 1212 are arranged to retain the construction panel slider in a folded position when the construction panel slider is in the folded position, for example as illustrated in FIG. 12. Any suitable connector may be used, as will be known to a person skilled in the art. Suitable connectors include latches, clasps, catches, hooks, straps, carabiners, ratchet straps, or tie-down straps. The connector 1210 may be fastened directly to side wall 114 or it may engage with one or more connector retaining members 1212 that are joined to side wall 114. Suitable connector retaining members include eye bolts, U-bolts, and i-bolts.

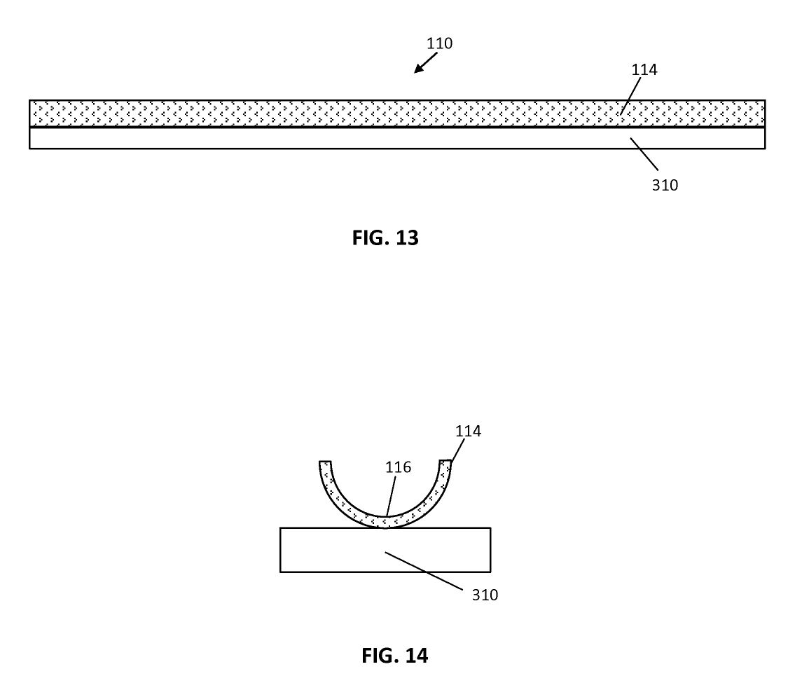

As illustrated by the embodiment depicted in FIGS. 13 and 14, the construction panel slider may comprise a slide surface 116 and side walls 114 that are integral and collectively of a half-pipe configuration. In the embodiment depicted in FIGS. 13 and 14, the slide surface 116 and side walls 114 are joined to base 310 along the center of base 310. However, in other embodiments, the slide surface and side walls 114 may be joined to base 310 at a position that is offset from the center of base 310; further base 310 may be integral with slide surface 116 and/or side walls 114.

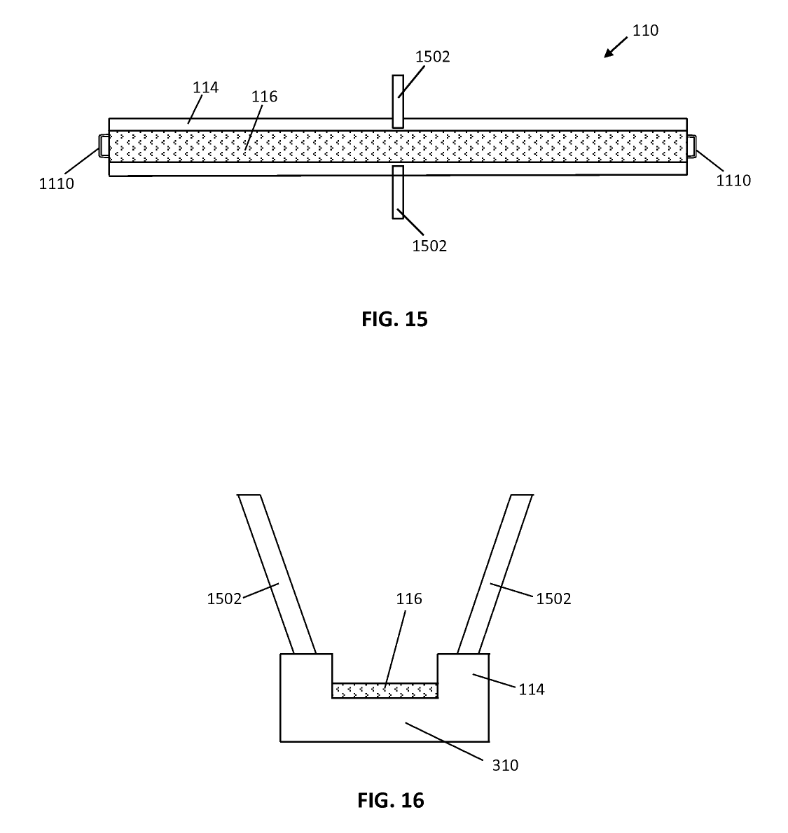

As illustrated by the embodiment depicted in FIGS. 15 and 16, the construction panel slider may comprise one or more panel guides 1502. These panel guides are rigid or semi-rigid structures that serve to assist a user in positioning a panel on the slide surface 116 of construction panel slider 110 by providing an area that is wider than slide surface 116. The panel guides 1502 may be made of any material that is suitable to help guide a construction panel towards the slide surface 116. Examples of suitable materials include Teflon, wood, steel, metal, polyvinyl chloride, vinyl, acrylics, and plastics. The panel guides 1502 should angle outward from the construction panel slider such that the distance between the top edges of opposing panel guides is greater than the width of slide surface 116. The panel guides 1502 may be removably joined to the construction panel slider 110 through insertion into complementary recesses (not shown) in the top face of side walls 114. In this embodiment, the panel guides 1502 can be inserted into the construction panel slider 110 when desired and removed when their presence is not desired. The panel guides 1502 may also be joined to construction panel slider 110 by a fastener. In an embodiment, panel guides 1502 are joined to construction panel slider 110 by a pivotal fastener, such that panel guides 1502 can be moved between a guide position as shown in FIGS. 15 and 16 and a folded position (not shown) where the panel guides 1502 lay flat along either the top face or the side of side wall 114. The folded position is intended for use when the construction panel slider 110 is in storage or transit, or when the construction panel slider is in use, but the use of panel guides 1502 is not desired. While FIGS. 15 and 16 depict a single pair of panel guides 1502, a construction panel slider 110 may be used with a single panel guide 1502, may be used with multiple panel guides, or may be used with multiple pairs of panel guides 1502, as desired.

Side walls 114 have been illustrated as flat planar structures, as depicted in FIGS. 1 to 12, 15, and 16 or as curved structures, as depicted in FIGS. 13 and 14. However, the side walls may be of other configurations so long as the side walls are adequate to impede a construction panel from sliding off the edge of the construction panel slider as the construction panel is being moved along the slide surface. For example, the side walls may be flat planar structures or curved structures and the side walls may be of perpendicular orientation or angled orientation relative to base 310.

The construction panel slider 110 should be sufficiently rigid to support the weight of a construction panel. For example, when the construction panel slider 110 is used to move a construction panel down a stairwell, for example stairwell 1010 in FIG. 10, the construction panel slider 110 should be sufficiently rigid to support the weight of the construction panel without giving way or bowing to the extent that it becomes difficult to move the construction panel along slide surface 116. Suitable materials for the base 310 and/or side walls 114 include wood, metal, plastic, plastic composite, polyvinyl chloride, and aluminum.

The length of the construction panel slider 110, measured along the slide surface in the direction parallel to the side walls, should be greater than the width of the construction panel slider, measured in the direction perpendicular to the side walls. When construction panel slider 110 comprises a plurality of sections 112, the length of the construction panel slider includes the combined length of all sections 112. In some embodiments the length of the construction panel slider is at least 16 inches. For example, the length of the construction panel slider may be at least 16 inches, at least 24 inches, at least 36 inches, at least 40 inches, at least 44 inches, at least 48 inches, at least 60 inches, at least 72 inches, at least 84 inches, at least 96 inches, at least 108 inches, at least 120 inches, at least 132 inches, at least 144 inches, at least 156 inches, at least 168 inches, at least 180 inches, or at least 192 inches. In an embodiment, the length of the construction panel slider is between about 16 inches and about 192 inches.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments.

Further, while the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting. It will be understood by persons skilled in the art that other variants and modifications may be made without departing from the scope of the invention as defined in the appended claims.

What is claimed is:

1. An apparatus for moving a construction panel by sliding along the apparatus, the apparatus comprising a plurality of sections, each section comprising:
a base comprising a top face, a bottom face, a first side, a second side, a first end and a second end;
a first side wall joined to the first side of the base and a second side wall joined to the second side of the base; and
a slide surface joined to the top face of the base and situated between the first and second side walls, wherein said slide surface comprises an upper face and the first and second side walls extend beyond the upper face of the slide surface;
wherein the sections are arranged end to end and adjacent sections are movably joined.

2. The apparatus of claim 1, wherein at least one section is an elongated section.

3. The apparatus of claim 1, wherein at least one section is of a different length than at least one other section.

4. The apparatus of claim 1, further comprising at least one attachment member joined to an end of the apparatus.

5. The apparatus of claim 1, further comprising a securement member joined to at least one end of the apparatus.

6. The apparatus of claim 1, wherein the first and second side walls are integral with the base.

7. The apparatus of claim 1, further comprising a connector joined to the outer surface of at least one side wall, wherein when the apparatus is in a folded position the connector is arranged to retain the apparatus in the folded position.

8. The apparatus of claim 1, wherein the adjacent sections are pivotally joined.

9. The apparatus of claim 1, further comprising at least one panel guide joined to the first or second side wall adjacent to the slide surface.

10. An apparatus for moving a construction panel by sliding along the apparatus, the apparatus comprising:
an elongated base comprising a top face, a bottom face, a first side, and a second side;
a first side wall joined to the first side of the base and a second side wall joined to the second side of the base; and
a slide surface joined to the top face of the base and situated between the first and second side walls,
wherein the slide surface comprises an upper face and the first and second side walls extend beyond the upper face of the slide surface.

11. The apparatus of claim 10, further comprising at least one attachment member joined to an end of the apparatus.

12. The apparatus of claim 10, further comprising a securement member joined to at least one end of the apparatus.

13. The apparatus of claim 10, further comprising at least one panel guide joined to the first or second side wall adjacent to the slide surface.

14. An apparatus for moving a construction panel by sliding along the apparatus, the apparatus comprising at least one section, each section comprising:
an elongated base comprising a top face;
a slide surface joined to the top face of the elongated base; and
a first side wall joined to one side of the slide surface and a second side wall joined to the opposite side of the slide surface, such that the slide surface is situated between spaced apart first and second side walls,
wherein the slide surface comprises an upper face and the first and second side walls extend beyond the upper face of the slide surface.

15. The apparatus of claim 14, wherein the first and second side walls are integral with the slide surface.

16. The apparatus of claim 15, wherein the first side wall, the slide surface, and the second side wall together are of a half-pipe configuration.

17. The apparatus of claim 14, comprising a plurality of sections, wherein the sections are arranged end to end and adjacent sections are movably joined.

18. The apparatus of claim 14, further comprising an attachment member joined to at least one end of the apparatus.

19. The apparatus of claim 14, further comprising at least one panel guide joined to the first or second side wall adjacent to the slide surface.
